(19) United States
(12) Patent Application Publication
(10) Pub. No.: US 2026/0146712 A1
(43) Pub. Date: May 28, 2026

(54) MODULAR COMPOSITE PANEL SYSTEM FOR HYDROGEN BLADDER CONTAINMENT

(71) Applicant: Float Air Inc., Dover, DE (US)

(72) Inventor: Ryan Kelly CONDRON, San Juan, PR (US)

(21) Appl. No.: 19/397,534

(22) Filed: Nov. 21, 2025

Related U.S. Application Data
(60) Provisional application No. 63/723,779, filed on Nov. 22, 2024.

(51) Int. Cl. F17C 1/16; B32B 3/06; B32B 5/02; B32B 5/26; B64B 1/58

(52) U.S. Cl. CPC F17C 1/16; B32B 3/06; B32B 5/02; B32B 5/26; B32B 2250/20; B32B 2250/40; B32B 2255/02; B32B 2255/205; B32B 2260/023; B32B 2260/046; B32B 2262/0269; B32B 2262/106; B32B 2307/30; B32B 2307/558; B32B 2307/581; B32B 2307/7242; B32B 2439/40; B64B 1/58; F17C 2201/0147; F17C 2201/018; F17C 2203/0607; F17C 2203/0629; F17C 2203/0646; F17C 2203/066; F17C 2203/0673; F17C 2209/22; F17C 2221/012; F17C 2260/011; F17C 2270/0197

(57) ABSTRACT

A modular composite panel system comprising a plurality of composite panels, each composite panel comprising co-cured layers including at least a carbon fiber layer and a resin between the carbon fiber layers, wherein each composite panel includes interlocking edge elements configured to mechanically connect with interlocking edge features of adjacent composite panels, and a hydrogen-impermeable bladder positioned within a structure formed by the plurality of composite panels when assembled, wherein the bladder is configured for hydrogen containment while the composite panels provide structural support. The composite panels may further include Kevlar layers co-cured with the carbon fiber layers and aluminum coatings applied to panel surfaces. The interlocking edge features may comprise dovetail connections, tongue-and-groove connections, or snap-fit mechanisms, and high-performance adhesives may be applied for bonding adjacent panels. The hydrogen-impermeable bladder may comprise thermoplastic polyurethane, multilayer polymer-metal laminates, or aluminum-coated films.

### CROSS-REFERENCE TO RELATED APPLICATIONS

This application claims priority to U.S. Provisional Application No. 63/723,779, titled Modular Kevlar-Carbon Fiber Co-Cured Panels with Integrated Hydrogen Bladder System, filed on Nov. 22, 2024, the disclosure of which is hereby incorporated by reference in its entirety.

### FIELD OF INVENTION

The present disclosure relates to modular composite panel systems, and more particularly to a modular composite panel system with integrated hydrogen bladder for structural and gas containment applications.

### BACKGROUND

Lightweight, high-strength composite structures are widely used across aerospace, transportation, and industrial applications where weight reduction and structural performance are paramount. Traditional composite panel systems typically employ single-material approaches or simple laminated structures that may not optimize both impact resistance and structural rigidity simultaneously. These conventional systems often face challenges in achieving the desired balance between strength, weight, and durability under extreme operating conditions.

In aerospace applications, composite panels serve as structural elements that must withstand significant mechanical loads, thermal cycling, and environmental stresses while maintaining dimensional stability and structural integrity. The manufacturing of such panels typically involves layup processes where fiber reinforcement materials are combined with resin matrix systems and cured under controlled temperature and pressure conditions. However, conventional manufacturing approaches may not fully address the need for modular assembly systems that allow for efficient construction, maintenance, and repair of large structures.

Gas containment systems, particularly those designed for hydrogen storage and transport, present additional challenges beyond structural requirements. Hydrogen's small molecular size and tendency to permeate through many materials creates demanding requirements for containment systems. Traditional approaches often rely on thick-walled pressure vessels or complex multi-barrier systems that can add substantial weight and volume to the overall system. The integration of gas containment functionality with structural load-bearing requirements has historically involved compromises between containment performance and structural efficiency.

Modular construction approaches offer potential advantages in terms of manufacturing scalability, assembly efficiency, and maintenance accessibility. However, achieving reliable connections between modular elements while maintaining both structural continuity and gas containment integrity presents technical challenges. Edge connection systems must provide adequate load transfer capabilities while accommodating manufacturing tolerances and thermal expansion effects. Known composite panel systems do not adequately address structural performance, gas containment, and modular assembly requirements.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a modular composite panel system is provided. The modular composite panel system comprises a plurality of composite panels, each composite panel comprising co-cured layers including at least a carbon fiber layer and a resin between the carbon fiber layers. Each composite panel includes interlocking edge elements configured to mechanically connect with interlocking edge features of adjacent composite panels. The modular composite panel system further comprises a hydrogen-impermeable bladder positioned within a structure formed by the plurality of composite panels when assembled. The bladder is configured for hydrogen containment while the composite panels provide structural support.

According to other aspects of the present disclosure, the modular composite panel system may include one or more of the following features. Each composite panel may further comprise a Kevlar layer co-cured with the carbon fiber layer. The Kevlar layer may be positioned as an outer layer for impact resistance and puncture protection. Each composite panel may further comprise an aluminum coating applied to at least one surface of the composite panel. The aluminum coating may be configured to improve hydrogen impermeability and thermal reflectivity. The interlocking edge features may comprise at least one of dovetail connections, tongue-and-groove connections, or snap-fit mechanisms. The modular composite panel system may further comprise a high-performance adhesive applied to the interlocking edge features for bonding adjacent composite panels. The high-performance adhesive may comprise epoxy or polyurethane. The hydrogen-impermeable bladder may comprise a material selected from at least one of thermoplastic polyurethane, multilayer polymer-metal laminates, or aluminum-coated films. The resin may comprise an epoxy-based resin compatible with the carbon fiber layer.

According to another aspect of the present disclosure, a method for constructing a hydrogen containment system using the modular panels is provided. The method comprises fabricating a plurality of modular composite panels, each panel comprising co-cured carbon fiber and resin layers with interlocking edge features. The method further comprises assembling the plurality of modular composite panels by connecting the interlocking edge features to form a structural shell. The method further comprises positioning a hydrogen-impermeable bladder within the structural shell formed by the assembled panels.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an exploded view of a modular composite panel system showing layered construction, according to aspects of the present disclosure.

FIG. 2a is a side view of a hull configuration according to aspects of the present disclosure.

FIG. 2b is a top sectional view of the hull configuration of FIG. 2a taken alone line b-b of FIG. 2a.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A modular composite panel system may comprise a plurality of composite panels that can be coupled to one another to form structures for hydrogen containment applications. Each composite panel may comprise co-cured layers that include at least two carbon fiber layers and a resin between the carbon fiber layers. The co-curing process may create a unified composite structure where the resin bonds the carbon fiber layers together under controlled heat and pressure conditions.

Each composite panel may include interlocking edge elements that are configured to mechanically connect with interlocking edge elements of adjacent composite panels. These interlocking edge elements may enable the modular assembly of multiple panels to create larger structures. The mechanical connection capability may allow for the construction of various geometric configurations depending on the specific application requirements and shape of the panels. For example, the panels can be hexagonal, rectangular, round, or any other shape.

The modular composite panel system may further comprise a hydrogen-impermeable bladder positioned within a structure formed by the plurality of composite panels when assembled. The bladder may be configured for hydrogen containment while the composite panels provide structural support. This dual-function approach may separate the gas containment responsibilities from the structural load-bearing requirements, allowing each component to be optimized for its specific function.

In certain examples, the interior bladder or barrier layer may incorporate an ultra-high-barrier nanocomposite coating comprising aligned 2D nanosheets. Examples include synthetic silicate nanosheets (e.g., Na-hectorite or related layered clays), graphene-oxide derivatives, MXene nanosheets, or other plate-like nanomaterials configured to create a tortuous gas-diffusion path. Such coatings may be applied using spray-coating, dip-coating, slot-die coating, or equivalent deposition methods and may achieve hydrogen or helium permeabilities many orders of magnitude below conventional barrier polymers

The composite panels provide external protection and structural integrity to the overall system, while the hydrogen-impermeable bladder may serve as the primary barrier for gas containment. The bladder may be constructed from materials that exhibit low permeability to hydrogen, or any other appropriate gas, ensuring effective gas retention within the assembled structure.

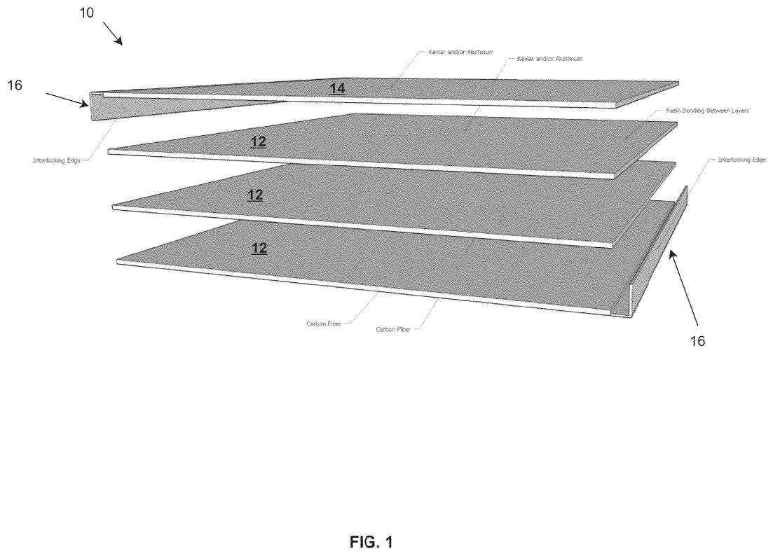

Referring to FIG. 1, each composite panel 10 may comprise a layered construction that includes multiple material components arranged in a specific configuration. Carbon fiber layers 12 may serve as the primary load-bearing structure within the composite panel, providing stiffness and contributing to a high strength-to-weight ratio. The carbon fiber layers 12 may be positioned as the main structural component that handles mechanical loads and maintains the structural integrity of the panel system.

As shown in FIG. 1, each composite panel 10 may also include one or more Kevlar layers 14 that may be co-cured with the carbon fiber layer during the manufacturing process. The Kevlar layer 14 may be positioned as an outer layer for impact resistance and puncture protection. In some cases, the Kevlar layer 14 may provide enhanced durability against external impacts and may protect the underlying carbon fiber structure from damage. The positioning of the Kevlar layer 14 as an outer layer may allow the composite panel to withstand harsh environmental conditions and mechanical stresses.

In some cases, the Kevlar layer 14 may be omitted entirely to reduce overall weight when impact resistance is not a primary consideration for the specific application. This selective inclusion of the Kevlar layer may allow for customization of the composite panel based on the performance requirements and weight constraints of different applications.

Each composite panel 10 may further comprise an aluminum coating applied to at least one surface of the composite panel. The aluminum coating may be configured to improve hydrogen impermeability and thermal reflectivity of the panel system. The aluminum coating may be applied to an outer surface of the composite panel 10, or alternatively, the aluminum coating may be applied to an inner face of the composite panel 10. In some cases, the aluminum coating may be applied to both the inner and outer surfaces to provide enhanced barrier properties.

The aluminum coating may provide UV resistance as an additional function beyond hydrogen impermeability and thermal reflectivity. This UV resistance capability may protect the underlying composite materials from degradation due to ultraviolet radiation exposure, particularly in aerospace applications where panels may be exposed to intense solar radiation.

The resin system used in the composite panels may comprise an epoxy-based resin that may be compatible with the carbon fiber layers 12. The epoxy-based resin may also be compatible with the Kevlar layer 14 when present in the layered construction. The resin may be applied between the layers during the co-curing process, creating bonds that integrate the separate material layers into a unified composite structure. The resin system may ensure proper adhesion between all layers and may contribute to the overall mechanical properties of the composite panel.

The co-curing process bonds the carbon fiber and resin layers together under controlled conditions. The co-curing process may create a seamless integrated structure where multiple material layers are simultaneously cured to form a unified composite panel. This manufacturing approach may ensure proper adhesion between all layers and may eliminate delamination issues that can occur with secondary bonding processes.

In some cases, fabricating a plurality of modular composite panels may comprise co-curing the carbon fiber and resin layers using a vacuum bagging process. The vacuum bagging process may involve placing the layered materials within a vacuum container and applying vacuum pressure to remove air and excess resin while the materials cure. This process may ensure uniform pressure distribution across the composite panel and may eliminate voids or air pockets that could compromise the structural integrity of the finished panel.

The vacuum bagging process may begin with the placement of carbon fiber layers and resin in a predetermined arrangement. A vacuum bag may then be sealed around the layered materials, and vacuum pressure may be applied to compress the layers together. Heat may be applied during the vacuum bagging process to activate the curing reaction of the resin system, creating chemical bonds that integrate the carbon fiber layers into a solid composite structure.

Alternatively, the co-curing process may be performed using an autoclave system as an alternative to vacuum bagging. The autoclave system may provide both heat and pressure in a controlled environment, allowing for precise control of the curing conditions. The autoclave process may involve placing the layered materials within the autoclave chamber and applying both elevated temperature and pressure simultaneously to achieve the co-curing of the composite layers.

The autoclave system may offer advantages in terms of pressure control and temperature uniformity compared to vacuum bagging processes. The autoclave may apply external pressure to the composite materials while maintaining precise temperature control throughout the curing cycle. This combination of heat and pressure may create a seamless integrated structure with enhanced mechanical properties and reduced porosity.

Positioning of a Kevlar layer may be maintained throughout the curing cycle through the use of tooling or fixtures that hold the layers in their designated positions. The resin system may flow between and around the Kevlar fibers during curing, creating a matrix that encapsulates the Kevlar and bonds the layer to the adjacent carbon fiber layers.

The application of heat and pressure during either the vacuum bagging or autoclave process may activate the chemical curing reactions within the resin system. The heat may raise the temperature of the resin to a level where cross-linking reactions occur, transforming the liquid resin into a solid polymer matrix. The pressure applied during the process may ensure intimate contact between all layers and may force out excess resin and trapped air.

The co-cured composite structure may include the carbon fiber layer and the resin system as integrated components that cannot be separated without destroying the composite panel. The resin system may penetrate into the carbon fiber weave or arrangement, creating a matrix composite where the resin transfers loads between individual carbon fibers and provides the composite panel with its final mechanical properties.

Referring again to FIG. 1, the interlocking edge features 16 may be integrated into the composite structure of each panel and may be configured to mechanically connect with corresponding interlocking edge features of adjacent panels. The interlocking edge features may be formed and/or attached during the co-curing process as part of the overall composite panel structure, ensuring that the edge geometry maintains the same material properties and structural integrity as the rest of the panel.

The interlocking edge features may comprise at least one of several different connection configurations. In some cases, the interlocking edge features may include dovetail connections that provide mechanical interlocking through angled surfaces that prevent separation of adjacent panels once assembled. The dovetail connections may include complementary male and female profiles where one panel includes a protruding dovetail shape and an adjacent panel includes a corresponding recessed dovetail shape.

Further, the interlocking edge features may alternatively include tongue-and-groove connections that enable mechanical connection between adjacent composite panels. The tongue-and-groove connections may include a protruding tongue element on one edge of a composite panel and a corresponding groove element on an adjacent edge of another composite panel. The tongue element may be dimensioned to fit within the groove element, creating a mechanical connection that aligns adjacent panels and provides resistance to separation forces.

In some cases, the interlocking edge features may include snap-fit mechanisms that allow for rapid assembly and disassembly of the modular composite panels. The snap-fit mechanisms may include flexible elements that deform during assembly and return to their original shape once the connection is complete, creating a mechanical lock between adjacent panels. The snap-fit mechanisms may provide audible or tactile feedback when the connection is properly engaged.

The interlocking edge features may be configured to receive a high-performance adhesive for bonding with adjacent panels. The geometry of the interlocking edge features may include channels, grooves, or recessed areas that retain adhesive material during assembly. The high-performance adhesive may comprise epoxy or polyurethane formulations that provide chemical bonding between adjacent composite panels in addition to the mechanical connection provided by the interlocking geometry.

The high-performance adhesive may be applied to the interlocking edge features before connecting adjacent panels during assembly. The adhesive may flow into the interface between mating interlocking edge features, creating a continuous bond line that distributes loads across the connection area. The combination of mechanical interlocking and adhesive bonding may provide enhanced connection strength compared to either connection method used alone.

In some cases, mechanical fasteners such as bolts or rivets may be integrated for additional security in panel connections. The mechanical fasteners may be positioned to pass through both the interlocking edge features and the adjacent panel material, creating a mechanical connection that supplements both the interlocking geometry and adhesive bonding. The mechanical fasteners may provide redundant connection capability that maintains panel assembly integrity even if the adhesive bond or interlocking features experience degradation.

The bolts used as mechanical fasteners may include threaded fasteners that pass through pre-drilled holes in the interlocking edge features of adjacent panels. The bolts may be secured with nuts or threaded inserts to create a clamping force that compresses the interlocking edge features together. The clamping force may enhance the effectiveness of adhesive bonding by maintaining intimate contact between bonded surfaces during adhesive curing. The rivets may be installed through holes in the interlocking edge features and may be expanded or deformed to create a mechanical connection that cannot be easily disassembled. The rivets may provide a connection method that does not require access to both sides of the panel assembly during installation.

The integration of mechanical fasteners with the interlocking edge features may allow for customization of connection strength based on the specific application requirements. Applications that experience high mechanical loads may incorporate multiple mechanical fasteners along each panel connection, while applications with lower load requirements may use fewer fasteners or may rely primarily on the interlocking geometry and adhesive bonding for panel connections.

The method for constructing a hydrogen containment system may include assembling the plurality of modular composite panels, and this assembly process may further comprise applying a high-performance adhesive to the interlocking edge features before connecting adjacent panels. The application of adhesive before panel connection may ensure proper distribution of the adhesive material within the interlocking geometry and may prevent air entrapment that could compromise bond strength.

The application process may involve dispensing the high-performance adhesive onto the interlocking edge features using various application methods. In some cases, the adhesive may be applied using a brush or spatula to ensure complete coverage of the bonding surfaces. Alternatively, the adhesive may be dispensed using automated equipment such as dispensing guns or robotic systems that provide consistent adhesive thickness and coverage.

The timing of adhesive application may be coordinated with the assembly sequence to ensure that the adhesive remains workable during panel connection. The high-performance adhesive may have a specified working time during which the panels can be positioned and adjusted before the adhesive begins to cure. The assembly process may be planned to complete panel connections within this working time to achieve proper bonding.

The interlocking edge features may be cleaned or prepared before adhesive application to remove contaminants that could interfere with bonding. The preparation process may include wiping the surfaces with solvents or using abrasive methods to create a clean, slightly roughened surface that promotes adhesive adhesion. The surface preparation may enhance the bond strength between the adhesive and the composite panel material.

The curing process for the high-performance adhesive may occur after the adjacent panels are connected and positioned. The curing may proceed at room temperature for some adhesive formulations, while other formulations may require elevated temperature to achieve full cure. The curing time may range from minutes to hours depending on the specific adhesive chemistry and environmental conditions.

During the curing process, the connected panels may be held in position using clamps, fixtures, or other restraining devices to maintain proper alignment and contact pressure. The restraining devices may prevent movement of the panels that could disrupt the adhesive bond formation. The clamping pressure may also help to minimize the adhesive bond line thickness, which can improve bond strength and reduce weight.

The cured high-performance adhesive may create a permanent bond between adjacent composite panels that distributes loads across the connection interface. The adhesive bond may transfer shear loads, tensile loads, and peel loads between connected panels, contributing to the overall structural performance of the assembled panel system. The adhesive may also provide sealing properties that prevent the passage of gases or liquids through the panel connections.

The hydrogen-impermeable bladder may be positioned within a structural shell formed by the assembled panels to provide primary hydrogen containment functionality. The bladder may serve as the primary barrier that prevents hydrogen gas from escaping the containment system, while the structural shell formed by the composite panels may provide external protection and structural support. This separation of functions may allow each component to be optimized for its specific role within the overall hydrogen containment system.

The hydrogen-impermeable bladder may comprise a material selected from at least one of several different material options that exhibit low hydrogen permeability characteristics. Alternatively, if the bladder is intended to contain a gas other than hydrogen, the bladder can be made of material that are impermeable to relevant /s/ The material selection for the bladder may be based on the specific application requirements, operating conditions, and performance criteria of the hydrogen containment system. Different bladder materials may offer varying combinations of flexibility, durability, and gas barrier properties.

In some cases, the hydrogen-impermeable bladder may comprise thermoplastic polyurethane as a bladder material. Thermoplastic polyurethane may provide flexibility that allows the bladder to conform to the internal geometry of the structural shell formed by the assembled composite panels. The thermoplastic polyurethane material may exhibit elastomeric properties that enable the bladder to expand and contract in response to pressure changes within the hydrogen containment system without compromising the gas barrier properties.

The thermoplastic polyurethane bladder material may be configured to provide primary hydrogen containment while the structural shell provides external protection. The thermoplastic polyurethane may form a continuous barrier that prevents hydrogen molecules from permeating through the bladder wall. The material may maintain its gas barrier properties across a range of operating temperatures and pressures encountered in hydrogen containment applications.

The flexibility of thermoplastic polyurethane may allow the bladder to accommodate shape changes that occur during filling and emptying cycles of the hydrogen containment system. The material may stretch and recover without developing cracks or tears that could compromise the gas containment function. The thermoplastic nature of the material may also allow for welding or heat sealing of bladder seams during manufacturing.

Alternatively, the hydrogen-impermeable bladder may comprise multilayer polymer-metal laminates as a bladder material option. The multilayer polymer-metal laminates may combine the flexibility of polymer materials with the gas barrier properties of metallic layers. The laminate construction may include alternating layers of polymer and metal materials that are bonded together to create a composite bladder material with enhanced performance characteristics.

The multilayer polymer-metal laminates may include polymer layers that provide flexibility and processability, while metal layers may provide enhanced hydrogen barrier properties. The metal layers within the laminate may be thin enough to maintain flexibility while providing effective resistance to hydrogen permeation. The polymer layers may protect the metal layers from mechanical damage and may provide adhesion between multiple metal layers within the laminate structure.

The multilayer construction may allow for customization of the bladder properties by varying the number, thickness, and composition of the individual layers within the laminate. Applications requiring enhanced gas barrier properties may incorporate additional metal layers, while applications requiring greater flexibility may include thicker polymer layers or fewer metal layers within the laminate structure.

In some cases, the hydrogen-impermeable bladder may comprise aluminum-coated films as a bladder material. The aluminum-coated films may include a polymer film substrate with a thin aluminum coating applied to one or both surfaces of the film. The aluminum coating may provide the primary hydrogen barrier function, while the polymer film substrate may provide mechanical support and flexibility to the bladder material.

The aluminum coating within the aluminum-coated films may be applied using various deposition processes such as vacuum metallization or sputtering. The coating thickness may be controlled to provide adequate hydrogen barrier properties while maintaining the flexibility needed for bladder applications. The aluminum coating may form a continuous metallic layer that blocks hydrogen permeation through the film substrate.

The polymer film substrate within the aluminum-coated films may be selected from materials that provide good adhesion with the aluminum coating and maintain flexibility under the operating conditions of the hydrogen containment system. The substrate material may also provide puncture resistance and tear strength that protect the aluminum coating from mechanical damage during bladder installation and operation.

In some cases, the hydrogen-impermeable bladder may comprise thin aluminum films as a bladder material option. The thin aluminum films may consist primarily of aluminum material formed into flexible sheets that can be shaped to conform to the internal geometry of the structural shell. The aluminum films may provide excellent hydrogen barrier properties due to the metallic structure that prevents hydrogen molecule permeation.

The thin aluminum films may be manufactured to specific thickness ranges that balance gas barrier performance with flexibility requirements. Thinner films may provide greater flexibility for conforming to complex geometries, while thicker films may offer enhanced puncture resistance and durability. The aluminum material may maintain its barrier properties across temperature ranges encountered in hydrogen containment applications.

The thin aluminum films may be joined using welding, brazing, or adhesive bonding techniques to create bladder assemblies that conform to the required containment geometry. The joining methods may create continuous seams that maintain the gas barrier properties of the aluminum material across the entire bladder surface. The metallic nature of the aluminum films may allow for welding techniques that create strong, gas-tight seams.

The positioning of the hydrogen-impermeable bladder within the structural shell formed by the assembled panels may involve installing the bladder after the composite panels are connected together. The bladder may be inserted through access openings in the structural shell and then inflated or expanded to conform to the internal geometry. Alternatively, the bladder may be positioned within the structural shell during the panel assembly process.

The method for constructing a hydrogen containment system may include positioning a hydrogen-impermeable bladder within the structural shell formed by the assembled panels as a final assembly step. The positioning process may ensure that the bladder is properly located within the structural shell and that all bladder connections and fittings are accessible for hydrogen filling and monitoring operations.

The bladder positioning may involve securing the bladder to the structural shell at specific attachment points to prevent excessive movement during operation. The attachment points may be designed to accommodate thermal expansion and contraction of both the bladder and structural shell materials. The attachment method may avoid creating stress concentrations in the bladder material that could lead to premature failure.

The assembly process for the modular composite panel system may involve connecting the interlocking edge features to form a structural shell that provides the external framework for hydrogen containment applications. The assembly process may begin with positioning adjacent composite panels so that their respective interlocking edge features are aligned for connection. The connection process may involve engaging the interlocking geometry between adjacent panels to create mechanical connections that hold the panels together in the desired configuration.

Assembling the plurality of modular composite panels by connecting the interlocking edge features to form a structural shell may proceed in a systematic sequence that builds up the overall structure progressively. The assembly sequence may start with connecting a base set of panels and then adding additional panels to expand the structural shell to the required dimensions. Each connection between adjacent panels may be completed before proceeding to the next connection to ensure proper alignment and structural integrity throughout the assembly process.

The connection process may involve inserting the interlocking edge features of one panel into the corresponding interlocking edge features of an adjacent panel. The insertion process may require applying force to engage the interlocking geometry, particularly for snap-fit mechanisms that may require deformation of flexible elements during connection. The connection may be considered complete when the interlocking edge features are fully engaged and the panels are properly aligned.

In some cases, the assembly process may involve multiple operators working simultaneously on different sections of the structural shell to reduce overall assembly time. The modular nature of the panel system may allow for parallel assembly operations where different groups of panels are connected independently and then joined together to form larger structural sections. This parallel assembly approach may be particularly beneficial for large hydrogen containment systems that incorporate numerous individual panels.

The panels may be manufactured in various sizes and shapes to fit specific design requirements of different hydrogen containment applications. The size variability may include panels with different length, width, and thickness dimensions and curvature that can be selected based on the structural loads, geometric constraints, and performance requirements of the specific application. Larger panels may be used in applications where fewer connections are desired, while smaller panels may provide greater flexibility for complex geometric configurations.

The shape variability of the manufactured panels may include rectangular, square, triangular, or curved panel geometries that enable the construction of structural shells with different overall shapes. Rectangular panels may be suitable for constructing cylindrical or box-shaped hydrogen containment systems, while curved panels may be used for spherical or aerodynamic configurations. The shape selection may be based on the intended application and the desired performance characteristics of the assembled structural shell.

Custom panel sizes and shapes may be manufactured to meet the specific requirements of unique applications that cannot be accommodated with standard panel configurations. The custom manufacturing capability may allow for optimization of the panel layout to minimize the number of connections required or to achieve specific structural performance targets. Custom panels may incorporate modified interlocking edge features that are designed to mate with standard panels while providing the required geometric characteristics.

The manufacturing process for panels of various sizes and shapes may utilize the same co-curing techniques and material compositions described previously, with modifications to the tooling and forming processes to achieve the desired panel geometry. The tooling may be designed to accommodate different panel dimensions while maintaining the same material properties and interlocking edge feature geometry across all panel sizes. This manufacturing approach may ensure compatibility between panels of different sizes within the same modular system.

The modular design of the panel system may enable quick assembly of hydrogen containment structures compared to traditional manufacturing approaches that require custom fabrication of entire containment vessels. The quick assembly capability may result from the standardized interlocking connections that eliminate the need for custom fitting or machining during assembly. The assembly process may be completed using standard tools and techniques that do not require specialized equipment or extensive training.

The modular design may enable quick maintenance of the assembled hydrogen containment system through the ability to access and service individual panels without disassembling the entire structure. Maintenance operations may include inspection of panel connections, replacement of adhesive seals, or repair of surface damage to individual panels. The modular approach may allow maintenance personnel to focus on specific areas of concern without affecting the integrity of the overall containment system.

In some cases, the modular design may enable replacement of damaged sections of the structural shell without requiring complete reconstruction of the hydrogen containment system. A damaged panel may be disconnected from adjacent panels by reversing the assembly process for the specific connections involved. The damaged panel may then be removed and replaced with a new panel that has identical dimensions and interlocking edge features.

The replacement process for damaged sections may involve disconnecting the interlocking edge features of the damaged panel from all adjacent panels. The disconnection process may require removal of any adhesive bonds or mechanical fasteners that secure the damaged panel to the surrounding structure. Once the damaged panel is removed, the replacement panel may be positioned and connected using the same assembly techniques used for original construction.

The ability to replace damaged sections may provide economic advantages by avoiding the need to replace entire hydrogen containment systems when localized damage occurs. The replacement capability may be particularly valuable in applications where the hydrogen containment system is subject to impact damage, wear, or environmental degradation that affects only specific areas of the structural shell. The modular approach may extend the service life of the overall system by allowing selective replacement of components that experience higher wear rates.

The quick assembly, maintenance, and replacement capabilities enabled by the modular design may reduce the downtime required for hydrogen containment system installation and service operations. The reduced downtime may provide operational advantages in applications where hydrogen storage or transport systems must maintain high availability. The modular approach may also reduce the inventory requirements for spare parts by allowing a single panel design to serve multiple positions within the structural shell.

The standardization of interlocking edge features across panels of different sizes and shapes may ensure that replacement panels can be sourced from standard inventory rather than requiring custom manufacturing for each replacement operation. This standardization may reduce the lead time for obtaining replacement panels and may lower the overall cost of system maintenance. The interchangeability of panels may also provide flexibility in system reconfiguration if the hydrogen containment requirements change over time.

The modular composite panel system may operate through coordinated interactions between the composite panels, interlocking edge features, adhesive bonding, and hydrogen-impermeable bladder to achieve dual functions of structural support and hydrogen containment. The system architecture may separate these two primary functions between different components, allowing each component to be optimized for its specific role within the overall containment system. This functional separation may enhance the performance and safety characteristics of the hydrogen containment system compared to single-component designs that attempt to provide both structural and containment functions within a single material system.

The composite panels may provide the primary structural framework that handles mechanical loads, environmental stresses, and impact forces encountered during operation of the hydrogen containment system. The carbon fiber layers within the composite panels may carry tensile and compressive loads that result from internal pressure, external forces, and thermal expansion effects. The structural load-bearing capability of the composite panels may allow the system to maintain its geometric configuration and structural integrity under various operating conditions without relying on the hydrogen-impermeable bladder for structural support.

The interlocking edge features may distribute structural loads between adjacent composite panels, creating a continuous load path throughout the assembled structural shell. The mechanical connection provided by the interlocking geometry may transfer shear forces, bending moments, and axial loads between connected panels, allowing the assembled structure to behave as an integrated structural system rather than a collection of individual panels. This load distribution capability may enable the modular panel system to achieve structural performance comparable to monolithic construction while maintaining the advantages of modular assembly.

The adhesive bonding between interlocking edge features may enhance the load transfer capability between adjacent composite panels by creating continuous bonding surfaces that distribute stresses across the connection interfaces. The adhesive bonds may carry both in-plane and out-of-plane loads between connected panels, contributing to the overall stiffness and strength of the assembled structural shell. The chemical bonding provided by the adhesive may supplement the mechanical connection of the interlocking features, creating redundant load paths that enhance the reliability of panel connections.

The hydrogen-impermeable bladder may operate independently of the structural loading system to provide gas-tight containment of hydrogen within the assembled structure. The bladder material may be selected and configured specifically for gas barrier performance without consideration of structural load-bearing requirements, allowing optimization of permeability characteristics, flexibility, and durability for hydrogen containment applications. This functional specialization may enable the bladder to achieve lower hydrogen permeation rates than would be possible with materials that must also provide structural support.

The decoupling of structural and containment functions may allow the composite panels to be designed with material compositions and geometric configurations that maximize structural performance without compromise for gas containment requirements. The carbon fiber content, layer orientation, and panel thickness may be optimized for strength, stiffness, and weight characteristics without consideration of hydrogen permeability. This design freedom may result in lighter and stronger structural shells compared to designs where the structural components must also provide gas containment.

The separation of functions may allow the hydrogen-impermeable bladder to operate at lower stress levels than would occur in single-wall containment systems where the containment barrier must also carry structural loads. The reduced stress levels in the bladder material may extend the service life of the gas containment system and may reduce the risk of failure modes that could compromise hydrogen containment. The bladder may experience primarily pressure-induced membrane stresses rather than the combination of pressure, bending, and impact stresses that affect the outer structural shell.

The outer composite shell may provide environmental protection for the hydrogen-impermeable bladder by shielding the bladder material from ultraviolet radiation, temperature extremes, mechanical impacts, and chemical exposure. The environmental protection capability of the composite shell may prevent degradation of the bladder material that could compromise gas containment performance over time. The composite panels may be formulated with UV-resistant resins and may incorporate protective coatings that maintain their protective properties throughout the service life of the system.

The impact resistance provided by the outer composite shell may protect the hydrogen-impermeable bladder from puncture or tearing that could result from external impacts or debris. The Kevlar layers within the composite panels may absorb impact energy and distribute impact loads across larger areas of the structure, reducing the stress concentrations that reach the bladder material. This impact protection may be particularly valuable in transportation applications where the hydrogen containment system may be subject to road debris, handling damage, or collision forces.

The thermal protection provided by the composite shell may shield the hydrogen-impermeable bladder from temperature fluctuations that could affect the material properties or dimensional stability of the bladder. The aluminum coatings on the composite panels may reflect radiant heat and may reduce the temperature variations experienced by the bladder material. The thermal protection may help maintain consistent gas containment performance across varying environmental conditions and may prevent thermal cycling damage to the bladder material.

The structural shell formed by the assembled composite panels may maintain the geometric configuration of the hydrogen containment system independently of the pressure state of the hydrogen-impermeable bladder. The structural shell may support the system geometry when the bladder is empty, partially filled, or fully pressurized, providing consistent external dimensions and connection interfaces regardless of the internal pressure conditions. This geometric stability may be important for applications where the hydrogen containment system must interface with other components or systems that require consistent positioning and alignment.

The pressure containment function may be shared between the hydrogen-impermeable bladder and the structural shell in a manner that optimizes the performance of both components. The bladder may provide the primary pressure barrier that prevents hydrogen escape, while the structural shell may provide backup containment capability and may limit the expansion of the bladder under pressure. This dual-barrier approach may enhance the safety of the hydrogen containment system by providing redundant containment capability.

The interaction between the bladder and structural shell may involve contact pressure that develops when the bladder expands under internal hydrogen pressure. The contact pressure may distribute the internal pressure loads across the inner surface of the structural shell, allowing the shell to contribute to pressure containment while maintaining its primary structural function. The contact pressure distribution may be controlled through the design of the bladder material properties and the internal geometry of the structural shell.

The modular nature of the composite panel system may allow for localized repair or replacement of structural components without compromising the hydrogen containment function provided by the bladder. Maintenance operations on the structural shell may be performed while the bladder remains in place and continues to provide gas containment, reducing the downtime required for system maintenance. The ability to service structural and containment components independently may improve the overall availability and reliability of the hydrogen containment system.

The operational flexibility provided by the dual-function design may allow the hydrogen containment system to accommodate various filling and emptying cycles without compromising either structural or containment performance. The structural shell may maintain its load-bearing capability throughout pressure cycling, while the bladder material may flex and recover to accommodate volume changes without developing fatigue damage. This operational flexibility may extend the service life of both structural and containment components compared to single-function designs that experience higher stress levels during pressure cycling.

The modular composite panel system may be specifically configured for hydrogen airship hull applications where the combination of lightweight construction, structural integrity, and gas containment capability provides advantages for aerial vehicle design. In hydrogen airship hull applications, the composite panels may form the external aerodynamic surface of the airship while the hydrogen-impermeable bladder contained within the structural shell provides the buoyant gas containment. The aerodynamic loads, structural loads from the airship framework, and environmental stresses may be carried by the composite panel assembly, while the bladder maintains the hydrogen gas that provides lift for the airship.

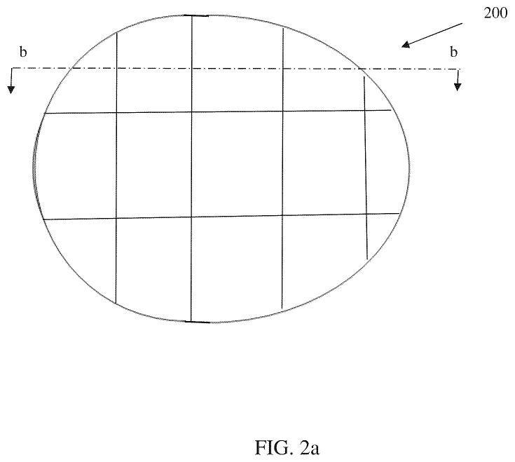

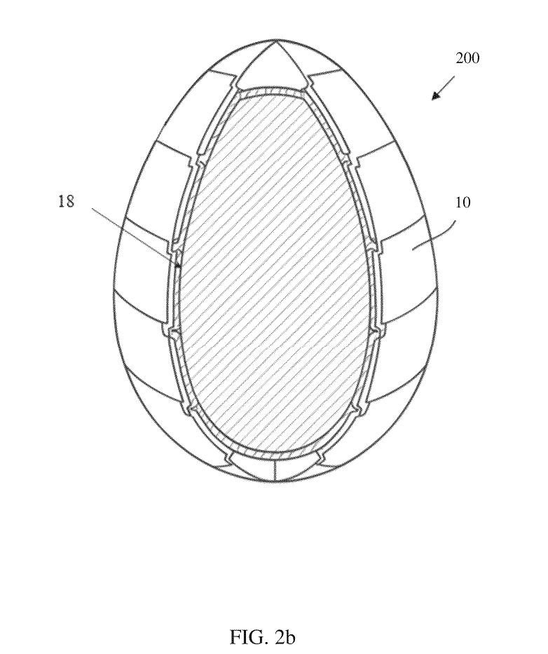

FIG. 2 illustrates a side view of an assembled modular composite panel structure forming an oval or elliptical configuration that can define, for example, a hull 200 for a lighter-than-air airship. FIG. 2b is a top sectional view of the hull configuration of FIG. 2a taken alone line b-b. The structure comprises multiple individual composite panels 10, as described above, arranged to create a continuous outer shell. The panels are positioned adjacent to one another with their interlocking edge elements connecting neighboring panels to form the complete assembly. Each panel section contributes to the overall structural framework while maintaining the curved geometry of the assembled configuration. In FIG. 2b, the hatched area, represents a sectional view that shows the internal volume contained within the assembled panel structure. The hydrogen-impermeable bladder 18, shown in cross section, is positioned within the internal volume of the shell.

The hydrogen airship hull configuration may utilize the modular assembly capability to construct large-scale hull structures that would be difficult to manufacture as single monolithic components. The modular panels may be assembled to create hull sections with complex curvatures and geometric transitions that conform to aerodynamic requirements for efficient flight performance. The interlocking edge features may enable the construction of smooth external surfaces that minimize aerodynamic drag while maintaining structural continuity across panel connections.

In hydrogen airship hull applications, the separation of gas containment and structural functions may enhance safety by providing redundant barriers against hydrogen release. The structural shell formed by the composite panels may serve as a secondary containment barrier in the event of bladder damage, while also protecting the bladder from external hazards such as bird strikes, weather damage, or ground handling impacts. The aluminum coatings on the composite panels may provide additional benefits in airship applications by reflecting solar radiation and reducing thermal heating of the hydrogen gas. Aluminum vapor deposition can be used to create a coating on the panels or bladder.

A number of implementations have been described. Nevertheless, it will be understood that various modifications may be made without departing from the spirit and scope of the disclosure. Accordingly, other implementations are within the scope of the following claims.

1. A modular composite panel system, comprising:
a plurality of composite panels, each composite panel comprising co-cured layers including at least a carbon fiber layer and a resin between the carbon fiber layers, wherein each composite panel includes interlocking edge elements configured to mechanically connect with interlocking edge features of adjacent composite panels; and
a hydrogen-impermeable bladder positioned within a structure formed by the plurality of composite panels when assembled, wherein the bladder is configured for hydrogen containment while the composite panels provide structural support.

2. The modular composite panel system of claim 1, wherein each composite panel further comprises a Kevlar layer co-cured with the carbon fiber layer.

3. The modular composite panel system of claim 2, wherein the Kevlar layer is positioned as an outer layer for impact resistance and puncture protection.

4. The modular composite panel system of claim 1, wherein each composite panel further comprises an aluminum coating applied to at least one surface of the composite panel.

5. The modular composite panel system of claim 4, wherein the aluminum coating is configured to improve hydrogen impermeability and thermal reflectivity.

6. The modular composite panel system of claim 1, wherein the interlocking edge features comprise at least one of:
dovetail connections;
tongue-and-groove connections; or
snap-fit mechanisms.

7. The modular composite panel system of claim 1, further comprising a high-performance adhesive applied to the interlocking edge features for bonding adjacent composite panels.

8. The modular composite panel system of claim 7, wherein the high-performance adhesive comprises epoxy or polyurethane.

9. The modular composite panel system of claim 1, wherein the hydrogen-impermeable bladder comprises a material selected from at least one of:
thermoplastic polyurethane;
multilayer polymer-metal laminates; or
aluminum-coated films.

10. The modular composite panel system of claim 1, wherein the resin comprises an epoxy-based resin compatible with the carbon fiber layer.

11. A method for constructing a hydrogen containment system, comprising:
fabricating a plurality of modular composite panels, each panel comprising co-cured carbon fiber and resin layers with interlocking edge features;
assembling the plurality of modular composite panels by connecting the interlocking edge features to form a structural shell; and
positioning a hydrogen-impermeable bladder within the structural shell formed by the assembled panels.

12. The method of claim 11, wherein fabricating the plurality of modular composite panels comprises co-curing the carbon fiber and resin layers using a vacuum bagging process.

13. The method of claim 11, wherein fabricating the plurality of modular composite panels further comprises incorporating a Kevlar layer with the carbon fiber and resin layers during co-curing.

14. The method of claim 13, wherein the Kevlar layer is positioned as an outer layer for impact resistance.

15. The method of claim 11, wherein assembling the plurality of modular composite panels further comprises applying a high-performance adhesive to the interlocking edge features before connecting adjacent panels.

16. The method of claim 11, wherein the hydrogen-impermeable bladder comprises thermoplastic polyurethane and is configured to provide primary hydrogen containment while the structural shell provides external protection.

17. A composite panel for modular assembly, comprising:
a co-cured composite structure including a carbon fiber layer and a resin system;
interlocking edge features integrated into the composite structure and configured to mechanically connect with corresponding interlocking edge features of adjacent panels; and
wherein the composite panel is configured to form part of a hydrogen containment system when assembled with other composite panels around a hydrogen-impermeable bladder.

18. The composite panel of claim 17, wherein the co-cured composite structure further comprises a Kevlar layer positioned as an outer layer for impact resistance and puncture protection.

19. The composite panel of claim 18, wherein the composite panel further comprises an aluminum coating applied to at least one surface and configured to improve hydrogen impermeability and thermal reflectivity.

20. The composite panel of claim 17, wherein the interlocking edge features comprise dovetail connections, tongue-and-groove connections, or snap-fit mechanisms configured to receive a high-performance adhesive for bonding with the adjacent panels.
